(19) United States
(12) Patent Application Publication
(10) Pub. No.: US 2026/0036350 A1
(43) Pub. Date: Feb. 5, 2026

(54) COOLANT CIRCULATION SYSTEM

(71) Applicant: Mazda Motor Corporation, Aki-gun (JP)

(72) Inventors: Shigeru Kobayashi, Aki-gun (JP); Yuma Miyauchi, Aki-gun (JP)

(21) Appl. No.: 19/262,406

(22) Filed: Jul. 8, 2025

(30) Foreign Application Priority Data
Jul. 31, 2024 (JP) 2024-124223

(51) Int. Cl. F25B 41/325; B60K 11/00; F25B 9/00; F25B 13/00

(52) U.S. Cl. CPC F25B 41/325; B60K 11/00; F25B 9/008; F25B 13/00; F25B 2313/031; F25B 2600/2513; F25B 2700/04

(57) ABSTRACT

To provide a coolant circulation system that supplies, to a motor, a gas phase coolant in which a superheat degree is suppressed to a low value. The coolant circulation system that circulates a coolant to cool a motor in a vehicle, in which a controller estimates, based on detection signals from sensors, a superheat degree of the coolant that flows out from second heat exchangers, the controller controls a flow rate in first expansion valves such that the superheat degree is maintained within a predetermined range from a lower limit threshold, which is larger than zero, and an upper limit threshold, and the controller supplies the coolant from the second heat exchangers to the motor through a channel.

### TECHNICAL FIELD

The present disclosure relates to a coolant circulation system, and particularly relates to a coolant circulation system for cooling a motor of a vehicle.

### BACKGROUND ART

Conventionally, a coolant circulation system that utilizes a refrigeration cycle has been used in a vehicle (see Japanese Patent Laid-Open No. 2022-186209, for example). The coolant circulation system described in Japanese Patent Laid-Open No. 2022-186209 is used for an on-vehicle air conditioning apparatus, and a condenser, an expansion valve, an evaporator, and a compressor are provided in a circulation channel in this order.

In general, in a coolant circulation system, although a gas-liquid mixed phase coolant is supplied to an evaporator, in order to prevent a return of a liquid phase coolant to a compressor, it is necessary to supply vaporized coolant, being superheated vapor, to the compressor. Therefore, the gas-liquid mixed phase coolant completely changes to a gas phase coolant in the evaporator.

In the system of Japanese Patent Laid-Open No. 2022-186209, a compressor is an electric compressor including an inverter, an electric motor, and a compression part, and a coolant that flows into the electric compressor from the evaporator absorbs heat from the inverter and the electric motor and, thereafter, flows into the compression part. Accordingly, in the system of Japanese Patent Laid-Open No. 2022-186209, when the electric compressor has a large power consumption, there is a risk of the coolant that flows into the compression part having an excessively high superheat degree.

For this reason, in the system of Japanese Patent Laid-Open No. 2022-186209, when the electric compressor has a large power consumption, by adjusting the flow rate of the coolant or the valve opening with the expansion valve, the coolant is not completely gasified by the evaporator, the coolant in a gas-liquid mixed phase is supplied to the inverter and the electric motor of the electric compressor, and the coolant is completely gasified by the inverter and the electric motor. Consequently, in this system, it is possible to prevent a situation in which the coolant that flows into the compression part has an excessively high superheat degree.

As described above, in the system of Japanese Patent Laid-Open No. 2022-186209, in addition to the ordinary evaporator, the inverter and the electric motor also serve as evaporators, and the coolant in a gas-liquid mixed phase can be supplied to these evaporators.

### SUMMARY

### Technical Problem

On the other hand, the inventors of the present disclosure have attempted to develop a new coolant circulation system in a vehicle, such as an electric vehicle, the new coolant circulation system including, as an evaporator, a relatively large-sized motor used to drive the vehicle or the like, in addition to an ordinary evaporator (for example, a heat exchanger or the like of an on-vehicle air conditioning apparatus). This new system is configured such that coolant is caused to directly flow into the motor (that is, including a space between a rotor and a stator).

In this case, since the coolant in a liquid phase has a relatively high viscosity, when the coolant in a liquid phase flows into the motor, a problem occurs in which stirring resistance is generated between the rotor and the stator during the rotation of the motor. The stirring resistance increases quadratically with respect to the rotational speed and hence, particularly in an ultra-high speed motor, a high stirring resistance is generated. Accordingly, the inventors of the present disclosure have found a technical problem in which, in a coolant circulation system in which the inside of the motor is directly cooled with coolant, it is necessary to ensure that the coolant flowing into the motor is gasified.

The inventors of the present disclosure also found a technical problem in which, to ensure that a coolant that is gasified due to an increase in specific enthalpy still has sufficient cooling capability, it is necessary to maintain the superheat degree of the gasified coolant at a low value. It is noted that the term “superheat” refers to a state in which coolant has a temperature elevated above the saturation temperature in the process where the coolant absorbs heat at a given pressure, thus being shifted from a gas-liquid mixed phase to a gas phase, and the term “superheat degree” refers to the extent to which the temperature is elevated from the saturation temperature.

The present disclosure has been made to solve the above-described technical problems, and it is an object of the present disclosure to provide a coolant circulation system that supplies, to the motor, a gas phase coolant in which a superheat degree is suppressed to a low value.

### Solution to Problem

To achieve the above-mentioned object, a coolant circulation system of the present disclosure is directed to a coolant circulation system that circulates a coolant to cool a motor in a vehicle, the coolant circulation system including: a coolant circulation circuit for a refrigeration cycle including, in a channel through which the coolant is circulated, a compressor, a first heat exchanger, a first expansion valve, a second heat exchanger, and the motor; the compressor compressing the coolant; the first heat exchanger causing the coolant, which is compressed, to radiate heat; the first expansion valve causing the coolant, which is caused to radiate heat, to expand; the second heat exchanger causing the coolant, which is expanded, to absorb heat; and the motor being disposed downstream of the second heat exchanger; a plurality of sensors that detect at least a pressure and a temperature of the coolant in the channel at an intermediate position between the second heat exchanger and the motor; and a controller that controls an opening degree of the first expansion valve. The controller estimates, based on a detection signal from the sensor, a superheat degree of the coolant that flows out from the second heat exchanger controls a flow rate in the first expansion valve such that the superheat degree is maintained within a predetermined range from a lower limit threshold, which is larger than zero, and an upper limit threshold, and supplies the coolant from the second heat exchanger to the motor through the channel.

In the present disclosure having such a configuration, the motor is incorporated in the refrigeration cycle as a heat source that elevates the specific enthalpy of the coolant, in addition to the second heat exchanger. That is, the present disclosure has a configuration in which although a gas-liquid mixed phase coolant is supplied to the second heat exchanger in the same manner as the ordinary refrigeration cycle, the coolant that absorbs heat from the second heat exchanger further cools the motor. At this point of operation, in the present disclosure, a flow rate control is performed by the first expansion valve such that a gasified coolant having sufficient cooling capability is supplied to the motor. That is, in the present disclosure, it is possible to ensure that the coolant that absorbs heat from the second heat exchanger is in a gas phase (that is, the superheat degree is greater than or equal to the predetermined lower limit threshold), and the superheat degree is not excessively high (that is, the superheat degree is less than or equal to the predetermined upper limit threshold) in order to allow the coolant to have sufficient cooling capability for the motor.

In the present disclosure, it is preferable that the controller increase the flow rate in the first expansion valve when the superheat degree is greater than the upper limit threshold. According to the present disclosure having such a configuration, when the superheat degree is greater than the upper limit threshold, by increasing the flow rate of the coolant to satisfy a demand for cooling by the second heat exchanger, the superheat degree can be reduced to the upper limit threshold or less.

In the present disclosure, it is preferable that the coolant circulation circuit further include, at the intermediate position in the channel, a liquid level sensor including a coolant storage chamber and a level meter that detects a liquid level of the coolant in the coolant storage chamber, and the controller reduce the flow rate in the first expansion valve when the superheat degree is less than the lower limit threshold, and the liquid level is rising based on a detection signal from the liquid level sensor. According to the present disclosure having such a configuration, when the superheat degree is lower than the lower limit threshold, and the liquid level is rising, it is determined that the specific enthalpy of the coolant in a gas-liquid mixed phase is further reduced, and hence, the superheat degree can be increased to the lower limit threshold by reducing the flow rate in the first expansion valve.

In the present disclosure, it is preferable that the coolant circulation circuit further include a branch channel and a second expansion valve, the branch channel allowing the first heat exchanger to communicate with the channel at the intermediate position, the second expansion valve being disposed in the branch channel, and the controller increase a flow rate in the second expansion valve when the controller determines that the superheat degree is greater than the upper limit threshold. According to the present disclosure having such a configuration, when the superheat degree is greater than the upper limit threshold, so that the coolant has low cooling capability for the motor, by using the second expansion valve to increase the flow rate of the coolant that bypasses the second heat exchanger and has a low specific enthalpy, the superheat degree can be reduced to the upper limit threshold or less.

In the present disclosure, it is preferable that the coolant circulation circuit further include a branch channel and a second expansion valve, the branch channel allowing the first heat exchanger to communicate with the channel at the intermediate position, the second expansion valve being disposed in the branch channel, and the controller reduce a flow rate in the second expansion valve when the superheat degree is less than the lower limit threshold. According to the present disclosure having such a configuration, when the superheat degree is less than the lower limit threshold, there is a high possibility of the coolant being in a gas-liquid mixed phase, and hence, by reducing the flow rate in the second expansion valve, the superheat degree can be restored to the lower limit threshold or more.

In the present disclosure, it is preferable that the coolant circulation circuit further include a third expansion valve in the channel at a position between the sensor and the motor, and the coolant that is further expanded by the third expansion valve be supplied to the motor. According to the present disclosure having such a configuration, by using the third expansion valve to cause the coolant in a gas phase to be further expanded, it is possible to supply to the motor the coolant at a lower temperature, at a lower pressure, and with increased cooling capability.

In the present disclosure, a coolant passage is formed in the motor in such a manner as to supply the coolant to a space between a stator and a rotor of the motor. According to the present disclosure having such a configuration, a gas phase coolant is supplied to the space in the motor and hence, it is possible to suppress an increase in stirring resistance when the motor is in operation.

In the present disclosure, the coolant is a CO₂ coolant. According to the present disclosure having such a configuration, a natural coolant can be used as the coolant.

In the present disclosure, the second heat exchanger includes a heat exchanger of an on-vehicle air conditioning apparatus and/or a heat exchanger for a vehicle battery. According to the present disclosure having such a configuration, it is possible to incorporate the ordinary heat exchanger for the vehicle in the coolant circulation system.

### Advantageous Effects

With the coolant circulation system according to the present disclosure, it is possible to supply, to the motor, a gas phase coolant in which a superheat degree is suppressed to a low value.

### BRIEF DESCRIPTION OF DRAWINGS

FIG. 1 is a schematic configuration diagram of a coolant circulation system according to an embodiment of the present disclosure.

FIG. 2 is an electrical block diagram of the coolant circulation system according to the embodiment of the present disclosure.

FIG. 3A is a perspective view of a motor of the coolant circulation system according to the embodiment of the present disclosure.

FIG. 3B is a transverse cross-sectional view of the motor of the coolant circulation system according to the embodiment of the present disclosure.

FIG. 3C is a longitudinal cross-sectional view of the motor of the coolant circulation system according to the embodiment of the present disclosure.

FIG. 4 is an explanatory diagram of a refrigeration cycle in the coolant circulation system according to the embodiment of the present disclosure.

FIG. 5A is an explanatory diagram of a refrigeration cycle for a case in which a cooling demand is high in the coolant circulation system according to the embodiment of the present disclosure.

FIG. 5B is a diagram illustrating restoration to a proper refrigeration cycle in the coolant circulation system according to the embodiment of the present disclosure.

FIG. 6A is an explanatory diagram of a refrigeration cycle for a case in which a cooling demand is low in the coolant circulation system according to the embodiment of the present disclosure.

FIG. 6B is a diagram illustrating restoration to a proper refrigeration cycle in the coolant circulation system according to the embodiment of the present disclosure.

FIG. 7 is a process flow of the coolant circulation system according to the embodiment of the present disclosure.

### DETAILED DESCRIPTION

Hereinafter, a motor system according to an embodiment of the present disclosure will be described with reference to attached drawings.

### Configuration of System

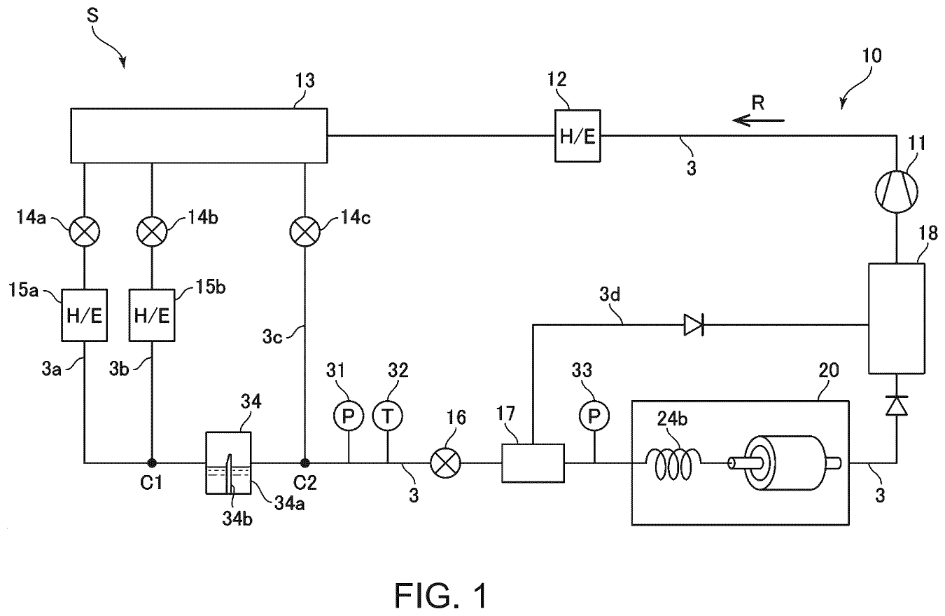

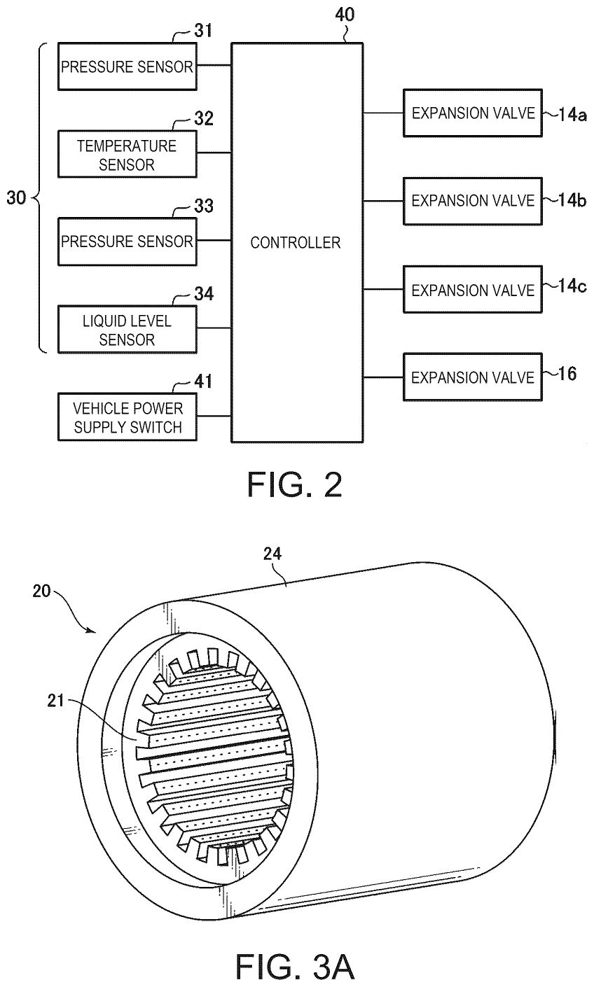

First, the overall configuration of a coolant circulation system according to the present embodiment will be described with reference to FIGS. 1 and 2. FIG. 1 is a schematic configuration diagram of the coolant circulation system according to the present embodiment, and FIG. 2 is an electrical block diagram of the coolant circulation system. A coolant circulation system S shown in FIG. 1 is mounted in a vehicle, such as an electric vehicle, for example, and is configured to cool a motor 20 that is used to drive the vehicle.

The coolant circulation system S forms a refrigeration cycle by using coolant, and includes a coolant circulation circuit 10, a plurality of sensors 30, and a controller 40. The coolant circulation circuit 10 includes, on piping or a channel 3 for a coolant R, a compressor 11, a first heat exchanger 12 serving as a condenser including a capacitor, a fan, and the like, a receiver 13 that receives the coolant R, upstream-side expansion valves 14a, 14b (examples of first expansion valves), an expansion valve 14c (example of a second expansion valve or a bypass expansion valve), second heat exchangers 15a, 15b serving as evaporators, a downstream-side expansion valve 16 (example of a third expansion valve), a gas-liquid separator 17, the motor 20, and an accumulator 18. The coolant R in the present embodiment is a mixture of a natural coolant (for example, CO₂) and lubricating oil.

On the downstream side of the receiver 13, the channel 3 is branched into channels 3a, 3b that communicate with the second heat exchangers 15a, 15b respectively. Coolant from the receiver 13 is supplied to the second heat exchangers 15a, 15b from the upstream-side expansion valves 14a, 14b respectively, through the channels 3a, 3b respectively. The second heat exchangers 15a, 15b are a heat exchanger of an on-vehicle air conditioning apparatus and a heat exchanger for a lithium battery that supplies electric power to the motor 20, and the like. The channels 3a, 3b merge at a junction C1.

A channel 3c that bypasses the second heat exchangers 15a, 15b is also provided to the channel 3. No heat exchanger is disposed in the channel 3c, so that coolant discharged from the expansion valve 14c is supplied to the downstream side without absorbing heat from a heat exchanger. In the present embodiment, the channel 3c merges with the channel 3 at a junction C2, which is located downstream of the junction C1.

The gas-liquid separator 17 separates liquid from the coolant R flowing through the channel 3 and containing lubricating oil. Although the liquid to be separated is lubricating oil, the liquid may contain coolant R in a liquid phase. The separated liquid is supplied to the accumulator 18 through a separation channel 3d. Accordingly, the gas-liquid separator 17 allows only coolant R in a gas phase to pass therethrough to a portion of the channel 3 located downstream of the gas-liquid separator 17, and only gasified coolant R is used to cool the motor 20. The separated liquid is sent to the accumulator 18, and is mixed with the coolant R (in a gas phase) that is used to cool the motor 20.

The plurality of sensors 30 include a pressure sensor 31, a temperature sensor 32, a liquid level sensor 34, and a pressure sensor 33, the pressure sensor 31 and the temperature sensor 32 being disposed between the junction C2 and the expansion valve 16, the liquid level sensor 34 being disposed between the junction C1 and the junction C2, the pressure sensor 33 being disposed between the expansion valve 16 and the motor 20. The pressure sensors 31, 33 detect the pressure of the coolant R in the channel 3. The temperature sensor 32 detects the temperature of the coolant R in the channel 3. The liquid level sensor 34 includes a coolant storage chamber 34a and a level meter 34b, the coolant storage chamber 34a being disposed in the channel 3, the level meter 34b detecting the liquid level of the coolant R in the coolant storage chamber 34a. The level meter 34b can continuously measure the level of the liquid surface of the coolant R in the coolant storage chamber 34a. The level meter 34b may be constituted by using a known method, such as a conductivity method, a radio wave method, or a float method.

A pressure sensor or a temperature sensor may be additionally provided in addition to the above-mentioned plurality of sensors. For example, a temperature sensor may be provided between the downstream-side expansion valve 16 and the motor 20, a pressure sensor and a temperature sensor may be additionally provided between the junction C1 and the junction C2 and, further, a pressure sensor and a temperature sensor may be provided in the liquid level sensor 34. The liquid level sensor 34 may be disposed between the junction C2 and the downstream-side expansion valve 16.

The controller 40 is a computing device that includes a processor, a memory, an output/input device, and the like. A predetermined control program, and a database including, for example, information on a pressure-enthalpy chart of the coolant R are stored in the memory. The controller 40 receives detection signals from the plurality of sensors 30, receives a power supply switch signal (on/off signal) from a vehicle power supply switch 41, receives other signals, and based on these signals, controls the upstream-side expansion valves 14a, 14b, 14c, the downstream-side expansion valve 16, and the like by reference to the database.

### Configuration of Motor

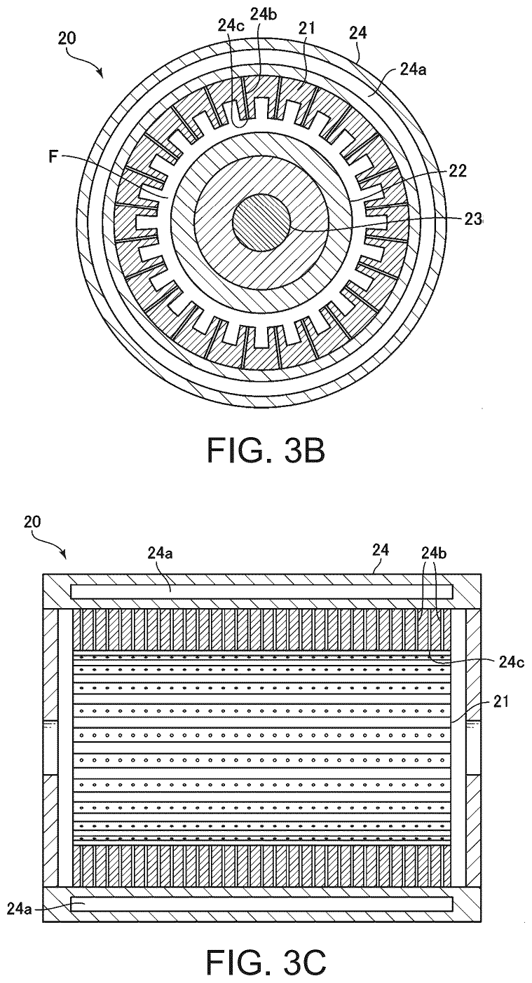

The configuration of the motor 20 according to the present embodiment will be described with reference to FIGS. 3A to 3C. FIG. 3A, FIG. 3B, and FIG. 3C are respectively a perspective view, a transverse cross-sectional view, and a longitudinal cross-sectional view of the motor. To facilitate understanding, some components are omitted in the respective drawings. The motor 20 is an ultra-high speed rotary motor, and is configured to be actuated at a high rotational speed above 30,000 rpm, for example.

The motor 20 includes a stator 21, a rotor 22, a rotor shaft (rotary shaft) 23, a bearing not shown in the drawings, a housing 24 having a substantially bottomed-cylindrical shape, and the like, a motor coil being wound in the stator 21, permanent magnets being disposed in the rotor 22, the rotor shaft 23 being fixed to the rotor 22, and extending in the axial direction, the housing 24 housing and supporting these components.

A storage passage 24a is formed in a cylindrical part of the housing 24. In addition, capillaries 24b, being a plurality of coolant passages, are formed in the stator 21 in such a manner as to penetrate through respective teeth in the radial direction. To prevent a decrease in electromagnetic performance of the stator 21, each capillary 24b is formed to have an extremely small diameter dimension in cross section. Note that in the present embodiment, each capillary 24b is formed to have a small cross section as described above and hence, liquid phase coolant R induces a high channel resistance, and thus it is difficult to cause the liquid phase coolant R to efficiently pass through the capillaries 24b. Therefore, it is extremely preferable to supply gas phase coolant R to the capillaries 24b. The coolant R supplied to the motor 20 from the channel 3 is supplied to the respective capillaries 24b, and is discharged to a space F between the stator 21 and the rotor 22 from opening parts 24c of the capillaries 24b to cool the motor coil and the like and, thereafter, returns to the channel 3 again, and is sent to the accumulator 18. Note that in the present embodiment, the storage passage 24a of the housing 24 can be used as the coolant storage chamber 34a of the liquid level sensor 34.

### Refrigeration Cycle of Coolant

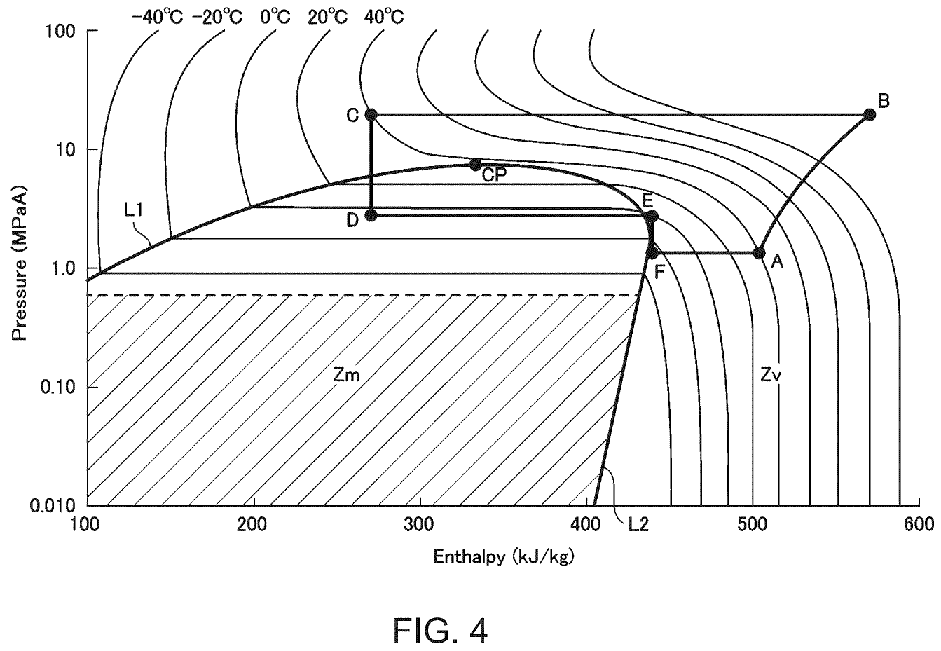

Next, the refrigeration cycle of the coolant R according to the present embodiment will be described with reference to FIG. 4. FIG. 4 shows the refrigeration cycle of the coolant R. The refrigeration cycle is shown on a pressure-enthalpy chart of the coolant R. In FIG. 4, specific enthalpy [KJ/kg] is shown on the horizontal axis, and absolute pressure [MPaA] is shown on the vertical axis. Isotherms are also partially shown in FIG. 4. The critical point of CO₂ coolant at 31° C. is 7.4 MPaA. In a wet vapor region Zm surrounded by a saturated liquid line L1 on the left side of a critical point CP and a saturated vapor line L2 on the right side of the critical point CP, the coolant R is in a gas-liquid mixed phase. Note that in the wet vapor region Zm, the coolant R may sublimate into dry ice at a predetermined pressure (0.52 MPaG) or less. In contrast, in a superheated vapor region Zv on the right side of the saturated vapor line L2, the coolant R is in a gas phase.

First, in the refrigeration cycle (A-B-C-D-E-F) in the present embodiment, a compression stroke (A-B) is performed by the compressor 11. The compressor 11 receives coolant R at high temperature and low pressure (gas) from the accumulator 18 through the channel 3 (point A), compresses the received coolant R, and discharges the coolant R at high temperature and high pressure (supercritical fluid) (point B). Next, a condensation stroke (B-C) is performed by the first heat exchanger 12. The first heat exchanger 12 receives the coolant R at high temperature and high pressure (point B), and causes the coolant R to be condensed and to radiate heat by heat exchange with the external environment (cool air, cooling water, or the like), thus generating the coolant R at intermediate temperature and high pressure (supercritical fluid) (point C).

Next, an expansion stroke (C-D) is performed by the upstream-side expansion valves 14a, 14b. The upstream-side expansion valves 14a, 14b reduce the pressure of the coolant R at intermediate temperature and high pressure to generate the coolant R at low temperature and intermediate pressure (gas-liquid mixture) (point D). Further, an evaporation stroke (D-E) is performed by the second heat exchangers 15a, 15b. The second heat exchangers 15a, 15b perform heat exchange with the coolant R at low temperature and intermediate pressure to cause the coolant R to evaporate and to absorb heat, thus ideally forming the coolant R at low temperature and intermediate pressure (gas) with a superheat degree of zero. Note that the temperatures at the point C and the point D may be changed depending on an outside air temperature or the like.

The present embodiment is characterized by further including a second expansion stroke (E-F), and a second evaporation stroke or a second heat absorption stroke (F-A). In the second expansion stroke (E-F), the downstream-side expansion valve 16 further reduces the pressure of the coolant R at low temperature and intermediate pressure to generate the coolant R at low temperature and low pressure (gas). Lastly, in the second evaporation stroke (F-A), the motor 20 exchanges heat with the coolant R at low temperature and low pressure (gas) and hence, the motor 20 is cooled, and the coolant R at high temperature and low pressure is generated. This coolant R at high temperature and low pressure is returned to the accumulator 18 (point A).

As described above, the refrigeration cycle of the present embodiment has the evaporation stroke (D-E) and the second evaporation stroke (F-A). In the evaporation stroke (D-E), gas-liquid mixed phase coolant R is used in the same manner as a general refrigeration cycle. In contrast, in the second evaporation stroke (F-A), coolant R in a gas phase is used. That is, in the second evaporation stroke (F-A), the coolant R in a gas phase is supplied to the motor 20 to suppress generation of stirring resistance caused by the coolant R in a liquid phase in the space F of the motor 20. In the second evaporation stroke (F-A), the coolant R is supplied to the space F of the motor 20 through the capillaries 24b and, to efficiently supply the coolant R, the coolant R in a gas phase is used.

### Summary of Adjustment of Flow Rate Performed by Expansion Valves

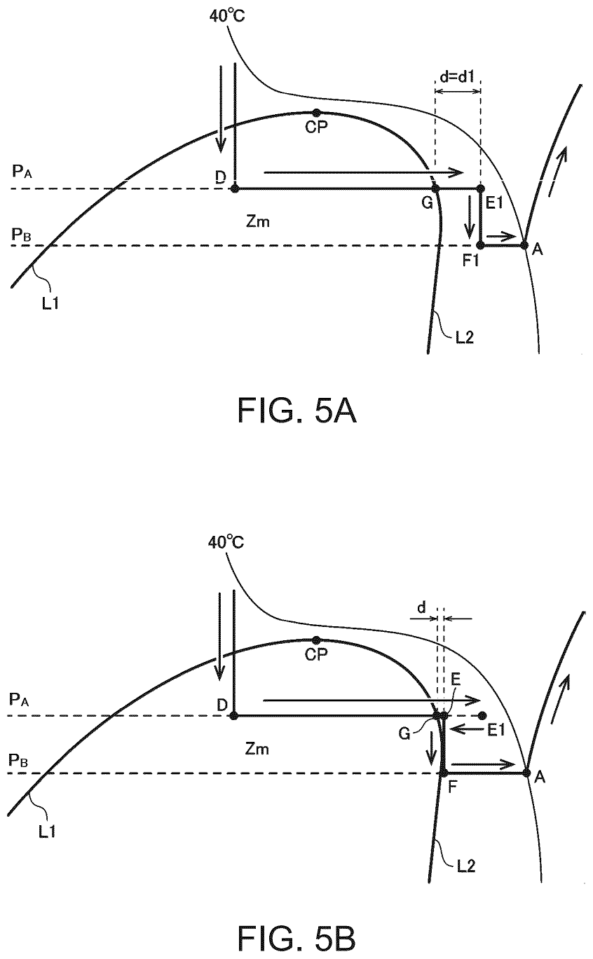

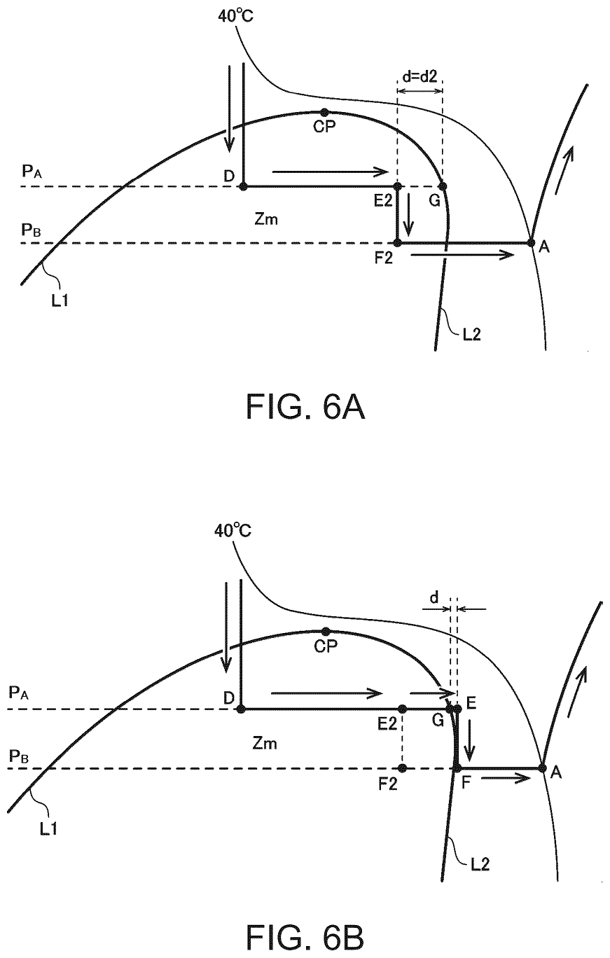

Next, a control of adjusting the flow rate of the coolant R performed by the expansion valves 14a, 14b, 14c will be described with reference to FIGS. 5A to 6B. In the present embodiment, the upstream-side expansion valves 14a, 14b, 14c are configured to reduce the pressure of the coolant R to a predetermined first pressure PA, and can adjust the flow rate by changing the valve openings. Further, the downstream-side expansion valve 16 is configured to reduce the pressure of the coolant R to a second pressure PB, which is lower than the first pressure PA, and the downstream-side expansion valve 16 can adjust the flow rate by changing the valve opening in the same manner.

FIG. 5A shows a case in which a demand for cooling by the second heat exchangers 15a, 15b is increased, so that cooling capability of the coolant R supplied from the expansion valves 14a, 14b is relatively reduced. In this case, at a point upstream of the expansion valve 16 (e.g. the junction C2), the coolant R (the point E1) is in a gas phase, and has a relatively high positive superheat degree d1 (d1>0). Thereafter, the coolant R that is reduced in pressure by the expansion valve 16 (point F1) has a small difference in specific enthalpy between the point F1 and the point A (for example, 40° C.), thus having a low cooling capability of the coolant R for the motor 20.

To avoid such a reduction in cooling capability, as shown in FIG. 5B, a control of increasing the valve opening is performed in such a manner as to increase the flow rate in the expansion valves 14a, 14b. Consequently, a state of the coolant R at the point upstream of the expansion valve 16 shifts from the point E1 to the point E. The superheat degree d of the coolant R at the point E is zero or a positive value close to zero (d≈0). The coolant R that is reduced in pressure by the expansion valve 16 thereafter (point F) has a large difference in specific enthalpy between the point F and the point A, thus having sufficient cooling capability for the motor 20. Note that in the present embodiment, when cooling capability is still insufficient (when the superheat degree is still high) even after the expansion valves 14a, 14b are brought into in a fully-opened state, it is possible to reduce the superheat degree by compensating for insufficiency in cooling capability by increasing the flow rate via the expansion valve 14c in the bypass channel 3c.

FIG. 6A shows a case in which a demand for cooling by the second heat exchangers 15a, 15b is reduced, so that the cooling capability of the coolant R supplied from the expansion valves 14a, 14b is relatively increased. In this case, at a point upstream of the expansion valve 16 (e.g. the junction C2), the coolant R (point E2) is in a gas-liquid mixed phase, and has a negative superheat degree d2 (d2<0). Note that in the wet vapor region Zm, the temperature of the coolant R is constant and hence, the term “negative superheat degree” does not refer to superheat degree in a strict sense. In the present embodiment, the term “negative superheat degree” refers to a difference between the specific enthalpy of the coolant R at the point E2 and the specific enthalpy at the same pressure and at the point G on the saturated vapor line L2. Thereafter, the coolant R that is reduced in pressure by the expansion valve 16 (point F2) still remains in a gas-liquid mixed phase. As described above, it is not preferable to supply the liquid phase coolant R of this coolant R to the motor 20.

Note that in the present embodiment, the liquid phase coolant R is recovered by the gas-liquid separator 17 before being supplied to the motor 20 and hence, it is possible to suppress the supply of the liquid phase coolant R to the motor 20. However, the total amount of the coolant R is reduced due to the recovery of the liquid phase coolant R and hence, a sufficient amount of the coolant R cannot be supplied to the motor 20, thus causing a reduction in cooling capability.

To avoid such a disadvantage, as shown in FIG. 6B, a control of reducing the valve opening is performed in such a manner as to reduce the flow rate in the expansion valves 14a, 14b. Consequently, at a point upstream of the expansion valve 16 (e.g. the junction C2), a state of the coolant R is shifted from the point E2 to the point E. As described with reference to FIG. 5B, the superheat degree d of the coolant R at the point E is zero or a positive value close to zero (d≈0), and the coolant R that is reduced in pressure by the expansion valve 16 (point F) has sufficient cooling capability for the motor 20. Note that in the present embodiment, first, a control of reducing the valve opening of the expansion valve 16 is performed and, when cooling capability is still excessively high even after such a control, a control of throttling the expansion valves 14a, 14b is performed.

### Process Flow

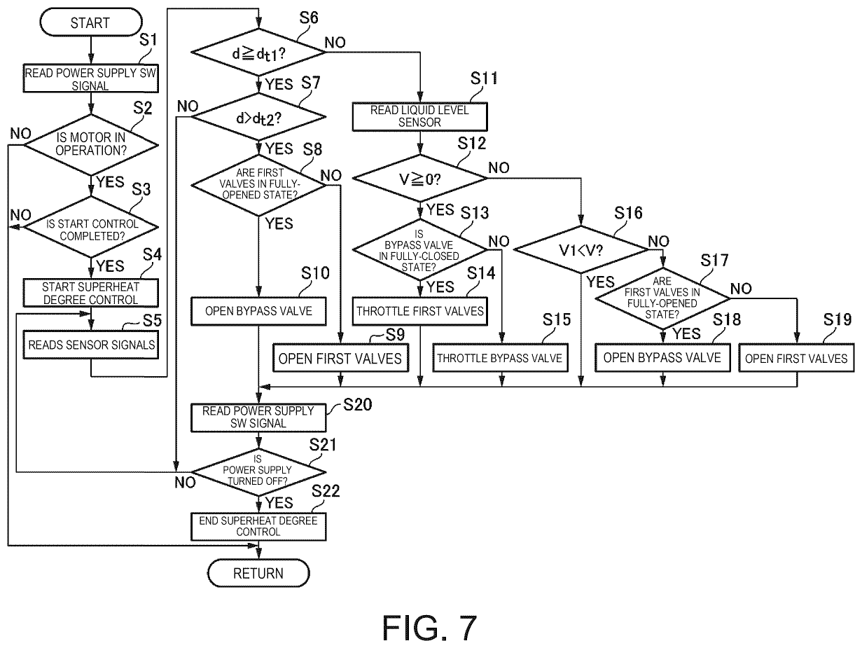

Next, a process flow of the coolant circulation system S of the present embodiment will be described with reference to FIG. 7. When the process is started, the controller 40 reads a vehicle power supply switch signal from the vehicle power supply switch 41 (S1) and, based on the vehicle power supply switch signal, the controller 40 determines whether the vehicle power supply is turned on, so that the motor 20 of the vehicle is in operation (S2). When a negative determination is made (S2; NO), although the process is ended, the controller 40 repeatedly performs the process shown in FIG. 7 for every predetermined time. In contrast, when an affirmative determination is made (S2; YES), the controller 40 determines based on a predetermined signal input whether a start control for the vehicle is completed (S3) and, after the start control is completed (S3; YES), the controller 40 starts a superheat degree control for the coolant R (S4). The superheat degree control is repeatedly performed until it is determined based on a vehicle power supply switch signal that the vehicle power supply is turned off (S20 to S22).

When the superheat degree control is started, the controller 40 reads detection signals from the plurality of sensors 30 (S5) and, based on the detection signals, determines whether the superheat degree d of the coolant R is maintained within a predetermined range (dₜ₁≤d≤dₜ₂) (S6, S7). Therefore, first, based on detection signals from the pressure sensor 31 and the temperature sensor 32, the controller 40 obtains the pressure P and the temperature T of the coolant R at the intermediate position between the second heat exchangers 15a, 15b and the expansion valve 16. Then, the controller 40 estimates the superheat degree d of the coolant R from the pressure P and the temperature T of the coolant R by reference to the information on the pressure-enthalpy chart of the coolant R.

In the wet vapor region Zm, even when the specific enthalpy of the coolant R is changed, the temperature T of the coolant R remains the same as the saturation temperature Tₛ until the coolant R is completely gasified. However, in the superheated vapor region Zv, the coolant R is completely gasified, and the temperature T of the coolant R increases with an increase in specific enthalpy. Accordingly, when the temperature T of the coolant R is higher than the saturation temperature Tₛ at the pressure P (T>Tₛ), it can be understood that the coolant R is completely gasified. The controller 40 can calculate the difference between the temperature T and the saturation temperature Tₛ as the superheat degree d (d=T−Tₛ).

In the present embodiment, when the superheat degree d is greater than or equal to the lower limit threshold dₜ₁ (S6; YES), and when the superheat degree d is less than or equal to the upper limit threshold dₜ₂ (S7; NO), the controller 40 determines that the coolant R is in a gas phase, and has a proper superheat degree and hence, the controller 40 maintains the valve openings of the expansion valves 14a to 14c. For example, the lower limit threshold dₜ₁ is 0.1° C. to 5° C., and the upper limit threshold dₜ₂ is 10° C. to 20° C.

In contrast, when the superheat degree d is greater than the upper limit threshold dₜ₂ (S7; YES), this situation refers to a state in which a cooling demand is increased (see FIG. 5A) and hence, when the expansion valves 14a, 14b are in a fully-opened state (S8; YES), the controller 40 opens the expansion valve 14c in the bypass channel 3c by a predetermined valve opening (S10), whereas when the expansion valves 14a, 14b are not in a fully-opened state (S8; NO), the controller 40 opens the expansion valves 14a, 14b by a predetermined valve opening (S9). Consequently, the flow rate of the coolant R is increased and hence, the superheat degree d of the coolant R is controlled to the upper limit threshold dₜ₂ or less. After the flow rates are adjusted by the expansion valves 14a to 14c, the controller 40 shifts to step S20.

When the superheat degree d is less than the lower limit threshold dₜ₁ (S6; NO), this situation refers to a state in which a cooling demand is reduced (see FIG. 6A). In this case, the controller 40 reads a detection signal from the liquid level sensor 34 (S11), and calculates the variation speed V of the liquid level from this detection signal to determine whether there is a rise in liquid level (S12). Note that detection signals read from the liquid level sensor 34 are stored in the memory over a predetermined time and hence, the controller 40 can calculate the liquid level at the current point in time and the variation speed of the liquid level.

In a case in which there is a rise in liquid level (S12; YES. That is, V≥0 is established, and it is presumed that the specific enthalpy of the coolant R has a tendency to be reduced), when the expansion valve 14c for bypass is in a fully-closed state (S13; YES), the controller 40 throttles the expansion valves 14a, 14b by a predetermined valve opening (S14), whereas when the expansion valve 14c is not in a fully-closed state (S13; NO), the controller 40 throttles the expansion valve 14c by a predetermined valve opening (S15). Consequently, the flow rate of the coolant R is reduced and hence, the superheat degree d of the coolant R is restored to the lower limit threshold dₜ₁ or more. After the flow rates are adjusted by the expansion valves 14a to 14c, the controller 40 shifts to step S20.

In contrast, when there is no rise in liquid level (S12; NO. That is, there is a fall in liquid level, and it is presumed that the specific enthalpy of the coolant R has a tendency to be increased), the controller 40 determines whether the variation speed V is greater than a predetermined speed threshold V1 (where V1<0) (S16). When an affirmative determination is made (S16; YES), it indicates a situation in which although the liquid level is falling (since V<0), the liquid level is falling relatively slowly and hence, the specific enthalpy of the coolant R is increased with time, and the superheat degree d is restored to the lower limit threshold dₜ₁ or more.

In contrast, when a negative determination is made (S16; NO), it indicates a situation in which the liquid level is falling rapidly and hence, after the superheat degree d of the coolant R is restored to the lower limit threshold dₜ₁, there is a possibility of the superheat degree d overshooting a proper range (from dₜ₁ to dₜ₂). Accordingly, in this case, when the expansion valves 14a, 14b are in a fully-opened state (S17; YES), the controller 40 opens the expansion valve 14c for bypass by a predetermined valve opening (S18), whereas when the expansion valves 14a, 14b are not in a fully-opened state (S17; NO), the controller 40 opens the expansion valves 14a, 14b by a predetermined valve opening (S19). Consequently, the flow rate of the coolant R is increased and hence, the superheat degree d of the coolant R is restored to the lower limit threshold du or more while preventing overshooting of the upper limit threshold dₜ₂. After the flow rates are adjusted by the expansion valves 14a to 14c, the controller 40 shifts to step S20.

Note that in the present embodiment, when the superheat degree d is less than the lower limit threshold dₜ₁ (S6; NO), the valve openings of the expansion valves 14a, 14b, 14c are adjusted on a case-by-case basis depending on the magnitude of the variation speed V of the liquid level. However, the configuration is not limited to the above, and a configuration may be adopted in which, regardless of a detection signal from the liquid level sensor 34, the flow rate of the coolant R is reduced by reducing one or a plurality of valve openings of the expansion valves 14a, 14b, 14c. In this case, it is particularly preferable to preferentially reduce the valve opening of the expansion valve 14c irrespective of the valve openings of the expansion valves 14a, 14b.

### Manner of Operation and Advantageous Effects

Next, the manner of operation and advantageous effects of the coolant circulation system S according to the present embodiment will be described.

The coolant circulation system S according to the present embodiment is the coolant circulation system S that circulates the coolant R to cool the motor 20 in a vehicle, the coolant circulation system S including: the coolant circulation circuit 10 that forms the refrigeration cycle including, in the channel 3 through which the coolant R is circulated, the compressor 11, the first heat exchanger 12, the first expansion valves 14a, 14b, the second heat exchangers 15a, 15b, and the motor 20, the compressor 11 compressing the coolant R; the first heat exchanger 12 causing the coolant R, which is compressed, to radiate heat; the first expansion valves 14a, 14b causing the coolant R, which is caused to radiate heat, to expand; the second heat exchangers 15a, 15b causing the coolant R, which is expanded, to absorb heat; and the motor 20 being disposed downstream of the second heat exchangers 15a, 15b; the plurality of sensors 30 (the pressure sensor 31, the temperature sensor 32) that detect at least the pressure P and the temperature T of the coolant R in the channel 3 at the intermediate position between the second heat exchangers 15a, 15b and the motor 20; and the controller 40 that controls the valve opening of the first expansion valves 14a, 14b. The controller 40 estimates, based on detection signals from the plurality of sensors 30, the superheat degree d of the coolant R that flows out from the second heat exchangers 15a, 15b, the controller 40 controls the flow rate in the first expansion valves 14a, 14b such that the superheat degree d is maintained within a predetermined range between the lower limit threshold dₜ₁, which is larger than zero, and the upper limit threshold dₜ₂ (S9, S14, S19), and the controller 40 supplies the coolant R from the second heat exchangers 15a, 15b to the motor 20 through the channel 3.

In the present embodiment having such a configuration, the motor 20 is incorporated, in the refrigeration cycle as a heat source that elevates the specific enthalpy of the coolant R, in addition to the second heat exchangers 15a, 15b. That is, the present embodiment has a configuration in which although a gas-liquid mixed phase coolant R is supplied to the second heat exchangers 15a, 15b in the same manner as the ordinary refrigeration cycle, the coolant R that absorbs heat from the second heat exchangers 15a, 15b further cools the motor 20. At this point of operation, in the present embodiment, a flow rate control is performed by the first expansion valves 14a, 14b such that a gasified coolant R having sufficient cooling capability is supplied to the motor 20. That is, in the present embodiment, it is possible to ensure that the coolant R that absorbs heat from the second heat exchangers 15a, 15b is in a gas phase (that is, the superheat degree d is equal to or greater than the predetermined lower limit threshold dₜ₁), and the superheat degree d is not excessively high (that is, the superheat degree d is less than or equal to the predetermined upper limit threshold dₜ₂) in order to allow the coolant R to have sufficient cooling capability for the motor 20.

According to the present embodiment, when the superheat degree d is greater than the upper limit threshold dₜ₂ (S7; YES), the controller 40 increases the flow rate in the first expansion valves 14a, 14b (S9). In the present embodiment having such a configuration, when the superheat degree d is greater than the upper limit threshold dₜ₂, by increasing the flow rate of the coolant R to satisfy the demand for cooling by the second heat exchangers 15a, 15b, the superheat degree d is reduced to the upper limit threshold dₜ₂ or less.

According to the present embodiment, the coolant circulation circuit 10 further includes, at the intermediate position in the channel 3, the liquid level sensor 34 including the coolant storage chamber 34a and the level meter 34b that detects the liquid level of the coolant R in the coolant storage chamber 34a, and when the superheat degree d is less than the lower limit threshold dₜ₁ (S6; NO), and the liquid level is rising based on a detection signal from the liquid level sensor 34 (S12; YES), the controller 40 reduces the flow rate in the first expansion valves 14a, 14b (S14). In the present embodiment having such a configuration, when the superheat degree d is lower than the lower limit threshold dₜ₁, and when the liquid level is rising, it is determined that the specific enthalpy of the coolant R in a gas-liquid mixed phase is further reduced and hence, the superheat degree d is increased to the lower limit threshold dₜ₁ or more by reducing the flow rate in the first expansion valves 14a, 14b.

According to the present embodiment, the coolant circulation circuit 10 further includes the branch channel 3c and the second expansion valve 14c, the branch channel 3c allowing the first heat exchanger 12 to communicate with the channel 3 at the intermediate position, the second expansion valve 14c being disposed in the branch channel 3c, and when the controller 40 determines that the superheat degree d is greater than the upper limit threshold dₜ₂ (S7; YES), the controller 40 increases the flow rate in the second expansion valve 14c. In the present embodiment having such a configuration, when the superheat degree d is greater than the upper limit threshold dₜ₂, so that the coolant R has low cooling capability for the motor 20, by using the second expansion valve 14c to increase the flow rate of the coolant R that bypasses the second heat exchangers 15a, 15b and has a low specific enthalpy, the superheat degree d is reduced to the upper limit threshold dₜ₂ or less.

According to the present embodiment, the coolant circulation circuit 10 further includes the branch channel 3c and the second expansion valve 14c, the branch channel 3c allowing the first heat exchanger 12 to communicate with the channel 3 at the intermediate position, the second expansion valve 14c being disposed in the branch channel 3c and, when the superheat degree d is less than the lower limit threshold dₜ₁ (S6; NO), the controller 40 reduces the flow rate in the second expansion valve 14c (S15). In the present embodiment having such a configuration, when the superheat degree d is less than the lower limit threshold dₜ₁, there is a high possibility of the coolant R being in a gas-liquid mixed phase and hence, by reducing the flow rate in the second expansion valve 14c, the superheat degree d is restored to the lower limit threshold dₜ₁ or more.

According to the present embodiment, the coolant circulation circuit 10 further includes the third expansion valve 16 in the channel 3 at a position between the plurality of sensors 30 (the pressure sensor 31, the temperature sensor 32) and the motor 20, and the coolant R that is further expanded by the third expansion valve 16 is supplied to the motor 20. In the present embodiment having such a configuration, by using the third expansion valve 16 to cause the coolant R in a gas phase to be further expanded, it is possible to supply to the motor 20 the coolant R at a lower temperature, at a lower pressure, and with increased cooling capability.

According to the present embodiment, the coolant passages (the capillaries 24b) are formed in the motor 20 in such a manner as to supply the coolant R to the space F between the stator 21 and the rotor 22 of the motor 20. In the present embodiment having such a configuration, a gas phase coolant R is supplied to the space F in the motor 20 and hence, it is possible to suppress an increase in stirring resistance when the motor 20 is in operation.

According to the present embodiment, the coolant is a CO₂ coolant. In the present embodiment having such a configuration, a natural coolant can be used as the coolant.

According to the present embodiment, the second heat exchangers 15a, 15b include a heat exchanger of an on-vehicle air conditioning apparatus and/or a heat exchanger for a vehicle battery. In the present embodiment having such a configuration, it is possible to incorporate an ordinary heat exchanger for the vehicle in the coolant circulation system S.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

Further, if used herein, a phrase of the form “at least one of A and B” means at least one A or at least one B, without being mutually exclusive of each other, and does not require at least one A and at least one B. If used herein, the phrase “and/or” means either or both of two stated possibilities.

### REFERENCE CHARACTER LIST

3, 3a to 3c channel
10 coolant circulation circuit
11 compressor
12 first heat exchanger
14a, 14b first expansion valve
14c second expansion valve
15a, 15b second heat exchanger
16 third expansion valve
17 gas-liquid separator
20 motor
21 stator
22 rotor
24 housing
24b capillary
31,33 pressure sensor
32 temperature sensor
34 liquid level sensor
40 controller
F space
R coolant
S coolant circulation system

1. A coolant circulation system that circulates a coolant to cool a motor in a vehicle, the coolant circulation system comprising:
a coolant circulation circuit that forms a refrigeration cycle including, in a channel through which the coolant is circulated, a compressor, a first heat exchanger, a first expansion valve, a second heat exchanger, and the motor; the compressor compressing the coolant; the first heat exchanger causing the coolant, which is compressed, to radiate heat; the first expansion valve causing the coolant, which is caused to radiate heat, to expand; the second heat exchanger causing the coolant, which is expanded, to absorb heat; and the motor being disposed downstream of the second heat exchanger;
a plurality of sensors that detect at least a pressure and a temperature of the coolant in the channel at an intermediate position between the second heat exchanger and the motor; and
a controller that controls an opening degree of the first expansion valve, wherein the controller:
estimates, based on a detection signal from the sensors, a superheat degree of the coolant that flows out from the second heat exchanger,
controls a flow rate in the first expansion valve such that the superheat degree is maintained within a predetermined range from a lower limit threshold, which is greater than zero, and an upper limit threshold, and
supplies the coolant from the second heat exchanger to the motor through the channel.

2. The coolant circulation system according to claim 1, wherein the controller increases the flow rate in the first expansion valve when the superheat degree is greater than the upper limit threshold.

3. The coolant circulation system according to claim 1, wherein
the coolant circulation circuit further includes, at the intermediate position in the channel, a liquid level sensor including a coolant storage chamber and a level meter that detects a liquid level of the coolant in the coolant storage chamber, and
the controller reduces the flow rate in the first expansion valve when the superheat degree is less than the lower limit threshold, and the liquid level is rising based on a detection signal from the liquid level sensor.

4. The coolant circulation system according to claim 1, wherein
the coolant circulation circuit further includes a branch channel and a second expansion valve, the branch channel allowing the first heat exchanger to communicate with the channel at the intermediate position, the second expansion valve being disposed in the branch channel, and
the controller increases a flow rate in the second expansion valve when the controller determines that the superheat degree is greater than the upper limit threshold.

5. The coolant circulation system according to claim 2, wherein
the coolant circulation circuit further includes a branch channel and a second expansion valve, the branch channel allowing the first heat exchanger to communicate with the channel at the intermediate position, the second expansion valve being disposed in the branch channel, and
the controller increases a flow rate in the second expansion valve when the controller determines that the superheat degree is greater than the upper limit threshold.

6. The coolant circulation system according to claim 1, wherein
the coolant circulation circuit further includes a branch channel and a second expansion valve, the branch channel allowing the first heat exchanger to communicate with the channel at the intermediate position, the second expansion valve being disposed in the branch channel, and
the controller reduces a flow rate in the second expansion valve when the superheat degree is less than the lower limit threshold.

7. The coolant circulation system according to claim 2, wherein
the coolant circulation circuit further includes a branch channel and a second expansion valve, the branch channel allowing the first heat exchanger to communicate with the channel at the intermediate position, the second expansion valve being disposed in the branch channel, and
the controller reduces a flow rate in the second expansion valve when the superheat degree is less than the lower limit threshold.

8. The coolant circulation system according to claim 3, wherein
the coolant circulation circuit further includes a branch channel and a second expansion valve, the branch channel allowing the first heat exchanger to communicate with the channel at the intermediate position, the second expansion valve being disposed in the branch channel, and
the controller reduces a flow rate in the second expansion valve when the superheat degree is less than the lower limit threshold.

9. The coolant circulation system according to claim 1, wherein the coolant circulation circuit further includes a third expansion valve in the channel at a position between the sensor and the motor, and the coolant that is further expanded by the third expansion valve is supplied to the motor.

10. The coolant circulation system according to claim 1, wherein a coolant passage is formed in the motor in such a manner as to supply the coolant to a space between a stator and a rotor of the motor.

11. The coolant circulation system according to claim 1, wherein the coolant is a CO₂ coolant.

12. The coolant circulation system according to claim 1, wherein the second heat exchanger includes a heat exchanger of an on-vehicle air conditioning apparatus and/or a heat exchanger for a vehicle battery.
